(19) United States
(12) Patent Application Publication
(10) Pub. No.: US 2024/0275541 A1
(43) Pub. Date: Aug. 15, 2024

(54) Signaling-less Data Transfer

(71) Applicant: Apple Inc., Cupertino, CA (US)

(72) Inventors: Amr Abdelrahman Yousef A. MOSTAFA, Munich (DE); Christian HOFMANN, Munich (DE); Panagiotis BOTSINIS, Munich (DE); Sameh M. ELDESSOKI, Munich (DE); Tarik TABET, Carlsbad, CA (US)

(21) Appl. No.: 18/476,675

(22) Filed: Sep. 28, 2023

Related U.S. Application Data
(63) Continuation of application No. 18/168,042, filed on Feb. 13, 2023.

(51) Int. Cl. H04L 5/00; H04W 12/033; H04W 12/06; H04W 12/106; H04W 68/00

(52) U.S. Cl. CPC H04L 5/0044; H04W 12/033; H04W 12/06; H04W 12/106; H04W 68/005

(57) ABSTRACT

A user equipment (UE) is configured to receive configuration information comprising multiple configuration sets, receive a paging message from a base station, the paging message configured to initiate a mobile terminating connection between the UE and the base station, identify a first configuration set assigned to the UE from the multiple configuration sets based on the paging message and exchange data with a network using the first configuration set, wherein exchanging data with network comprises at least one of receiving downlink data and transmitting uplink data.

### BACKGROUND

A user equipment (UE) may establish a connection to a base station to receive data from the network and/or transmit data to the network. The UE and the base station may perform a procedure that includes a signaling exchange (e.g., random access, etc.) prior to the data transfer. The signaling exchange requires UE resources (e.g., power, processing, etc.), radio resources and network node resources (e.g., power, processing, etc.). However, in some scenarios, the signaling exchange that precedes that data transfer is an inefficient use of UE and network resources.

### SUMMARY

Some exemplary embodiments are related to a method performed by a user equipment (UE). The method includes receiving configuration information comprising multiple configuration sets, receiving a paging message from a base station, the paging message configured to initiate a mobile terminating connection between the UE and the base station, identifying a first configuration set assigned to the UE from the multiple configuration sets based on the paging message and exchanging data with a network using the first configuration set, wherein exchanging data with network comprises at least one of receiving downlink data and transmitting uplink data.

Other exemplary embodiments are related to a user equipment having a transceiver configured to communicate with a base station and a processor communicatively coupled to the transceiver. The processor is configured to receive configuration information comprising multiple configuration sets, receive a paging message from the base station, the paging message configured to initiate a mobile terminating connection between the UE and the base station, identify a first configuration set assigned to the UE from the multiple configuration sets based on the paging message and exchange data with a network using the first configuration set, wherein exchanging data with network comprises at least one of receiving downlink data and transmitting uplink data.

Still further exemplary embodiments are related to a method performed by a base station. The method includes transmitting a paging message to a user equipment (UE), the paging message configured to initiate a mobile terminating connection between the UE and the base station, identifying a first configuration set assigned to the UE from multiple configuration sets and exchanging data with the UE using the first configuration set, wherein exchanging data with network comprises at least one of receiving downlink data and transmitting uplink data.

Additional exemplary embodiments are related to a base station having a transceiver configured to communicate with a user equipment (UE) and a processor communicatively coupled to the transceiver. The processor is configured to transmit a paging message to the UE, the paging message configured to initiate a mobile terminating connection between the UE and the base station, identify a first configuration set assigned to the UE from multiple configuration sets and exchange data with the UE using the first configuration set, wherein exchanging data with network comprises at least one of receiving downlink data and transmitting uplink data.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram for signaling less data transfer (SLDT) according to various exemplary embodiments.

FIG. 5 shows an exemplary SLDT data payload structure according to various exemplary embodiments.

FIG. 6 shows a signaling diagram for SLDT connection Type1 according to various exemplary embodiments.

FIG. 7 shows a signaling diagram for computation offloading using SLDT connection Type1 according to various exemplary embodiments.

FIG. 8 shows a signaling diagram for computation offloading using SLDT connection Type1 according to various exemplary embodiments.

FIG. 9 shows a signaling diagram for SLDT connection Type2 according to various exemplary embodiments.

FIG. 10 shows a signaling diagram for localized paging according to various exemplary embodiments.

FIG. 11 shows a signaling diagram for paging the UE from multiple cells for SLDT according to various exemplary embodiments.

FIG. 12 shows an example of a mapping between a paging message and a SLDT configuration set according to various exemplary embodiments

FIG. 13 shows an example of a paging record that may be provided in a paging message according to various exemplary embodiments.

FIG. 14 shows an example of a static allocation of resources for SLDT according to various exemplary embodiments.

FIG. 15 shows an example of a dynamic allocation of resources for SLDT according to various exemplary embodiments.

### DETAILED DESCRIPTION

The exemplary embodiments may be further understood with reference to the following description and the related appended drawings, wherein like elements are provided with the same reference numerals. The exemplary embodiments introduce a data transfer mechanism for a wireless communication system. Throughout this description, the data transfer mechanism may be generally referred to as a “signaling-less data transfer (SLDT).” However, reference to the term signaling less data transfer (SLDT) is merely provided for illustrative purposes, different entities may refer to similar concepts by a different name. As will be described in more detail below, compared to some conventional approaches, SLDT uses techniques that require less overhead on user equipment (UE) resources (e.g., power, processing, etc.), radio resources (e.g., common, shared, etc.) and network node resources (e.g., power, processing, etc.).

The exemplary embodiments are described with regard to a UE. However, reference to a UE is merely provided for illustrative purposes. The exemplary embodiments may be utilized with any electronic component that is configured with the hardware, software, and/or firmware to exchange information and data with the network. Therefore, the UE as described herein is used to represent any appropriate electronic component.

The exemplary embodiments are also described with regard to a sixth generation (6G) network. However, reference to a 6G network is merely provided for illustrative purposes. The exemplary embodiments may be utilized by any appropriate type of network.

The UE may establish a connection to a base station of the network to receive data from the network and/or transmit data to the network. In some conventional approaches, the UE and the base station may perform a procedure that includes a signaling exchange prior to the data transfer. For example, a cell access procedure (e.g., random access) may be performed. The signaling exchange requires UE resources, radio resources and network node resources.

The exemplary embodiments are described with regard to a mobile terminating connection that is triggered by the network via a paging message. After the paging message, a data transfer may be performed in the uplink and/or downlink. However, in contrast to conventional approaches where the UE initiates a random access procedure or some other type of signaling exchange in response to the paging message, the exemplary embodiments allow the UE to directly receive downlink data and/or transmit uplink data.

In 6G, some UEs may be stationary or have limited mobility (e.g., Internet of Things (IoT) devices, sensors, etc.). Other UEs may only require a small amount of data (e.g., one or two packets). For these types of devices, establishing a connection in the normal manner (e.g., cell access procedure) may add unnecessary overhead to UE resources, radio resources and/or network node resources. Accordingly, the exemplary embodiments introduced herein may provide benefits to these types of devices in a 6G system. However, the exemplary embodiments are not limited to these types of devices or 6G. The exemplary techniques introduced herein may be used by any appropriate type of device in any appropriate type of wireless communication system.

As indicated above, the exemplary embodiments include techniques for performing a data transfer between a UE and a network without the need for a cell access procedure or some other type of signaling exchange in response to the paging message. In addition, the exemplary embodiments introduce security schemes for SLDT, different SLDT connection types, paging mechanisms and techniques for resource allocation. The exemplary embodiments described herein may be performed independently from one another, in conjunction with other currently implemented data transfer mechanisms, in conjunction with future implementations of data transfer mechanisms and independently from other data transfer mechanisms.

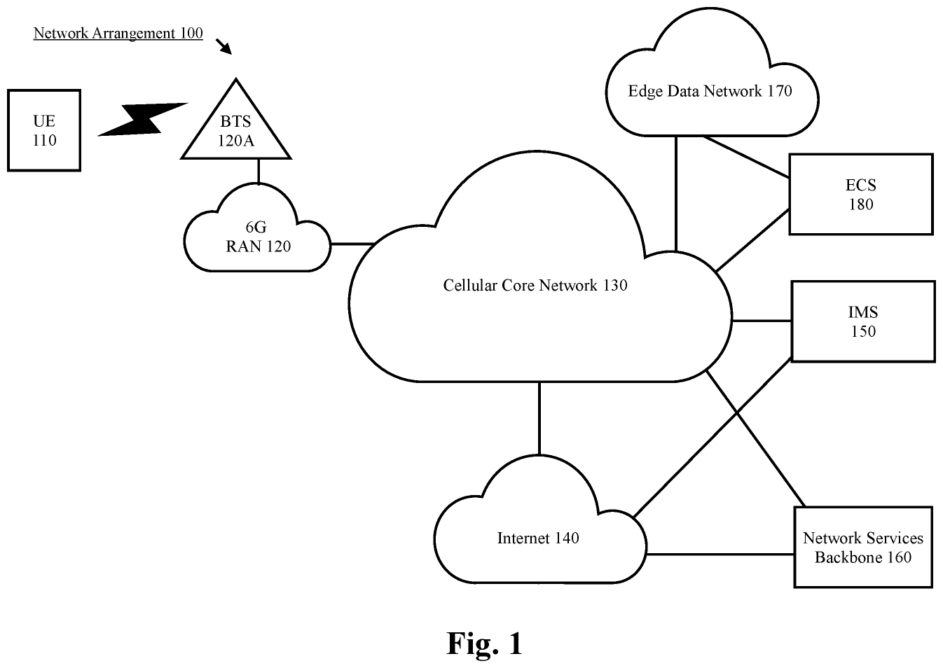

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, sensors, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 6G radio access network (RAN) 120. However, the UE 110 may also communicate with other types of networks (e.g., a fifth generation (5G) new radio (NR) RAN, a 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with at least the 6G RAN 120. Therefore, the UE 110 may have a 6G chipset to communicate with the 6G RAN 120.

The 6G RAN 120 may be a portion of a cellular network that may be deployed by a network carrier (e.g., Verizon, AT&T, T-Mobile, etc.). The 6G RAN 120 may include, for example, cells or base stations (eNBS, gNBs, macrocells, microcells, small cells, femtocells, etc.) that are configured to send and receive traffic from UEs that are equipped with the appropriate cellular chip set.

In the network arrangement 100, the UE 110 may connect to the 6G PAN 120 via the base station (BTS) 120A. Those skilled in the art will understand that any association procedure may be performed for the UE 110 to connect to the 6G RAN 120. For example, as discussed above, the 6G RAN 120 may be associated with a particular cellular provider where the UE 110 and/or the user thereof has a contract and credential information (e.g., stored on a SIM card). Upon detecting the presence of the 6G PAN 120, the UE 110 may transmit the corresponding credential information to associate with the 6G PAN 120. More specifically, the UE 110 may associate with a specific base station (e.g., BTS 120A). However, as mentioned above, reference to the 6G PAN 120 is merely for illustrative purposes and any appropriate type of PAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

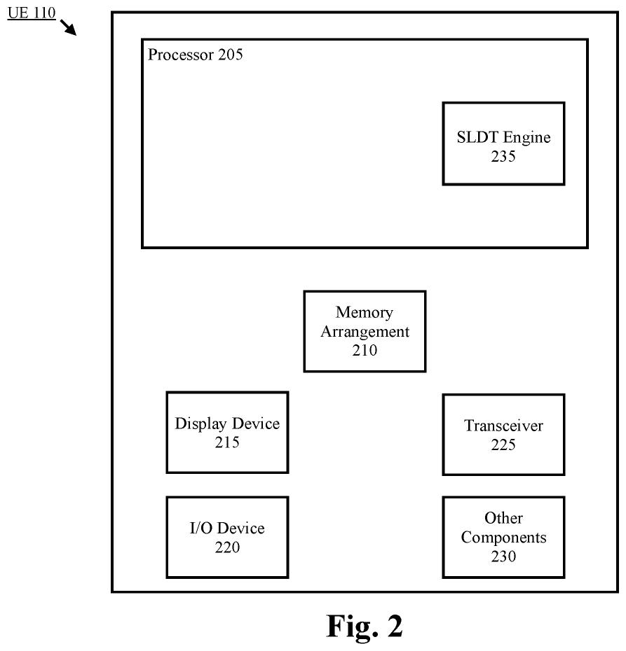

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a SLDT engine 235. The SLDT engine 235 may perform a variety of operations related to exemplary embodiments described herein. The operations may include, but are not limited to, receiving SLDT configuration information from the network, receiving a paging message, receiving data and transmitting data.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 6G PAN 120 and/or any other appropriate type of network. Accordingly, the transceiver 225 may operate on a variety of different frequencies or channels (e.g., set of consecutive frequencies).

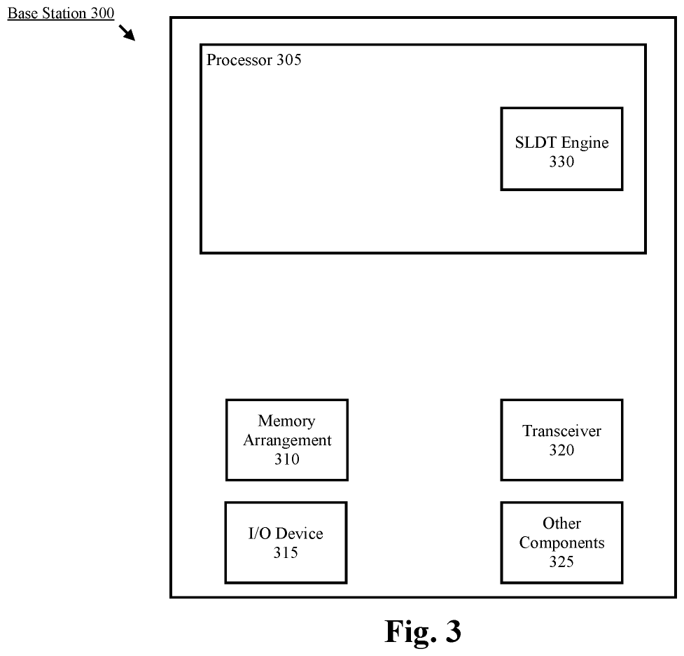

FIG. 3 shows an exemplary base station 300 according to various exemplary embodiments. The base station 300 may represent any access node (e.g., BTS 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a SLDT engine 330. The SLDT engine 330 may perform a variety of operations related to exemplary embodiments described herein. The operations may include, but are not limited to, transmitting SLDT configuration information from the network, transmitting a paging message, receiving data from the UE 110 and transmitting data to the UE 110.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

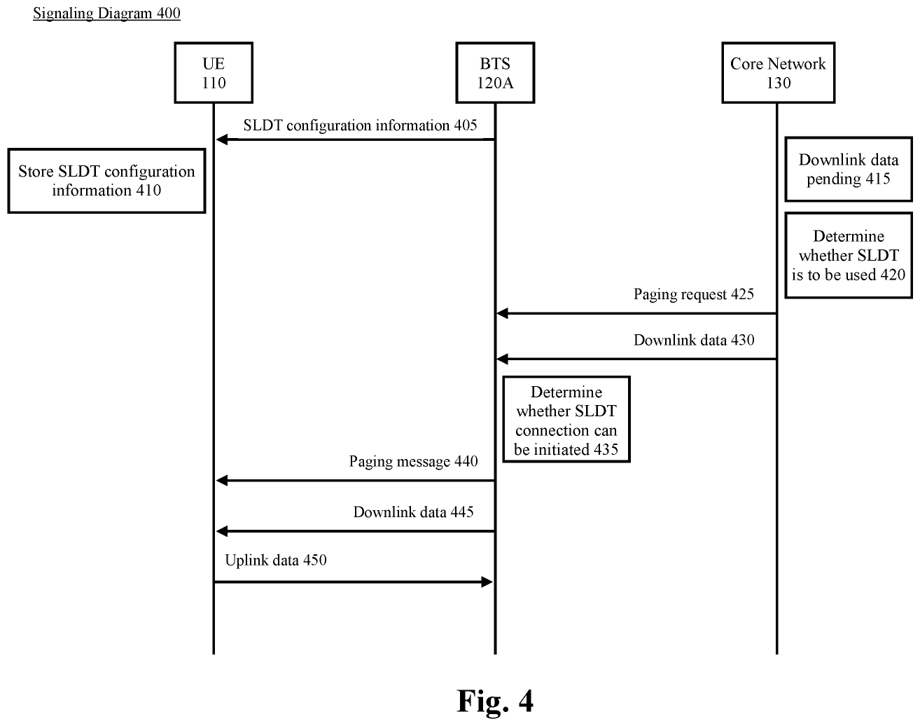

FIG. 4 shows a signaling diagram 400 for SLDT according to various exemplary embodiments. The signaling diagram 400 includes the UE 110, the BTS 120A and the core network 130.

As indicated above, in accordance with SLDT, the UE 110 may receive a paging message. In response to the paging message, the UE 110 may directly receive downlink data and/or transmit uplink data using preconfigured information instead of performing random access or some other type of signaling exchange with the base station. The signaling diagram 400 will provide a general overview of an example of SLDT within the context of the network arrangement 100 of FIG. 1. Specific aspects of SLDT are described in more detail below after the description of the signaling diagram 400.

In 405, the BTS 120A sends SLDT configuration information to the UE 110. The SLDT configuration information may be provided in a system information block (SIB), a dedicated configuration message or in any other appropriate type of message or messages.

Throughout this description, SLDT configuration information may generally refer to information that may be used by the UE 110 to perform a data transfer. For example, the SLDT configuration may be a semi-dedicated configuration that may be used by the UE 110 in response to a trigger condition (e.g., paging message).

In some embodiments, SLDT configuration information for one or more SLDT configuration sets may be broadcast by the BTS 120A where each SLDT configuration set may correspond to resources assigned to single specific UE. For example, the UE 110 may receive a SIB from the BTS 120A that includes SLDT configuration information for multiple SLDT configuration sets. The UE 110 may be assigned one of the SLDT configuration sets and the other SLDT configuration sets may be assigned to other UEs. This may ensure that there is no contention for the SLDT resources.

In 410, the UE 110 stores the SLDT configuration information. As will be described in more detail below, the UE 110 waits for a trigger condition (e.g., paging message) to use the SLDT configuration information to receive data from network and/or transmit data to the network.

In 415, there is downlink data pending for the UE 110 at the core network 130. In 420, the core network determines whether SLDT may be used to perform a data transfer with the UE 110. For example, the core network 130 may evaluate conditions such as, but not limited to, amount of pending downlink data, a device type of the UE 110, capabilities of the UE 110 and a mobility state of the UE 110. In this example, it is assumed that SLDT may be used to perform a data transfer with the UE 110. However, in an actual deployment scenario, the conditions for SLDT may not be satisfied and the core network 130 may decide to wait until the SLDT conditions are satisfied, perform the data transfer using a different mechanism or behave in any other appropriate manner.

In 425, the core network 130 sends a paging request to the BTS 120A. In this example, the paging request may indicate the amount of pending downlink data for the UE 110 and SLDT is allowed to be performed with the UE 110. In 430, the core network 130 sends the downlink data to the BTS 120A.

In 435, the BTS 120A determines whether an SLDT connection can be initiated. For example, the BTS 120A may consider whether radio resources are available for SLDT, if the core network 130 has allowed SLDT for the UE 110, the amount of downlink data and cell load. In this example, it is assumed that SLDT may be initiated. However, in an actual deployment scenario, the BTS 120A may determine that the SLDT connection cannot be initiated and the BTS 120A may decide to wait until the SLDT connection is able to be initiated, provide the downlink data using a different mechanism or behave in any other appropriate manner.

Returning to the UE 110 side, during 415-435, the UE 110 may use one or more operating modes. In this example, the UE 110 may be in an idle mode where the UE 110 is generally not exchanging data with the network and radio resources are not being assigned to the UE 110 within the network. However, when in the idle state, the UE 110 may monitor for information and/or data transmitted by the network. This example is merely provided for illustrative purposes and is not intended to limit the exemplary embodiments in any way. Specific examples of the different types of operating modes that may be used by the UE 110 will be described in more detail below after the description of the signaling diagram 400.

In 440, the BTS 120A sends a paging message to the UE 110. The paging message may indicate to the UE 110 the SLDT is to be used for a subsequent data transfer. However, reference to a paging message is merely provided for illustrative purposes. The exemplary embodiments may use any appropriate type of signal to trigger SLDT.

In 445, the UE 110 receives downlink data from the BTS 120A using the SLDT configuration information. For example, based on the timing and/or contents of the paging message in 440, the UE 110 may know that a particular SLDT configuration is to be used which indicates the time and frequency resources to be used for the downlink data.

Similarly, in 450, the UE 110 transmits uplink data to the BTS 120A using the SLDT configuration information. For example, based on the timing and/or contents of the paging message in 440, the UE 110 may know that a particular SLDT configuration is to be used which indicates the time and frequency resources to be used for the uplink data. In this example, both downlink data and uplink data are exchanged. However, in actual operating scenarios, only downlink data may be received during the SLDT connection or only uplink data may be transmitted during the SLDT connection.

In this example, after the transmission of the uplink data in 450, the UE 110 may return to the idle operating mode. As mentioned above, the signaling diagram 400 is provided as a general overview of SLDT and is not intended to limit the exemplary embodiments in any way. Specific aspects of SLDT such as, but not limited to, security schemes for SLDT, SLDT connection types, paging mechanisms and techniques for resource allocation are described in detail below.

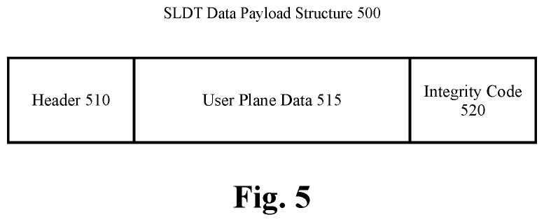

According to one aspect, the exemplary embodiments include security schemes for SLDT that use integrity protection and user plane protection. The following exemplary SLDT security schemes are described with regard to an exemplary SLDT data payload structure, an example of which is shown in FIG. 5.

FIG. 5 shows an exemplary SLDT data payload structure 500 according to various exemplary embodiments. The exemplary SLDT payload structure 500 includes a header 510, user plane data 515 and integrity code 520.

The exemplary SLDT payload structure 500 may be used for downlink or uplink data. Since SLDT relates to a mobile terminating connection where the network is initiating the connection for a particular UE, the UE context (e.g., capabilities, configuration state, security context, etc.) may already be known on the network side and thus, may be used by the network for downlink data payload preparation and uplink data payload processing. This is in contrast to mobile originating connections where the network needs to know the UE identity before it can retrieve its associated context.

The header 510 may be configured to include information for synchronizing the security parameters (e.g., keys, etc.) used by the UE and the network. Since the exemplary SLDT payload structure 500 may be used for either downlink or uplink communication, the user plane data 515 may include downlink data or uplink data. In addition, the user plane data 515 may be encrypted via non-access stratum (NAS)/access stratum (AS) security parameters. The integrity code 520 may be generated via a NAS/AS security context and include information that is used for authentication and data integrity.

In one approach, authentication and user plane data protection may be achieved using a NAS layer security context. For example, a NAS security context may be used for user plane data protection via encryption and authenticated via a NAS layer generated integrity code. In another approach, authentication and user plane data protection may be achieved using the UE stored AS context. For example, the AS security context may be used for user plane protection via encryption and authenticated via an AS layer generated integrity code. In a further approach, authentication and user plane data protection may be achieved using early establishment of an AS security context. The above examples are not intended to limit the exemplary embodiments in any way. If authentication and user plane protection is required, the exemplary embodiments may use the above referenced schemes or may use any other appropriate type of security scheme for SLDT data payload. In other embodiments, authentication and user plane protection is not required and may use any other appropriate type of security technique for SLDT data payload.

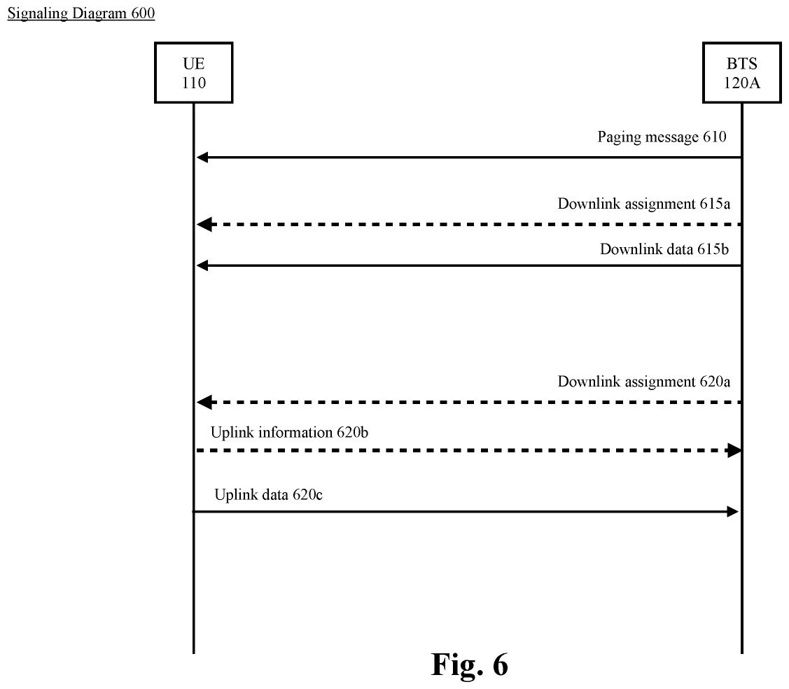

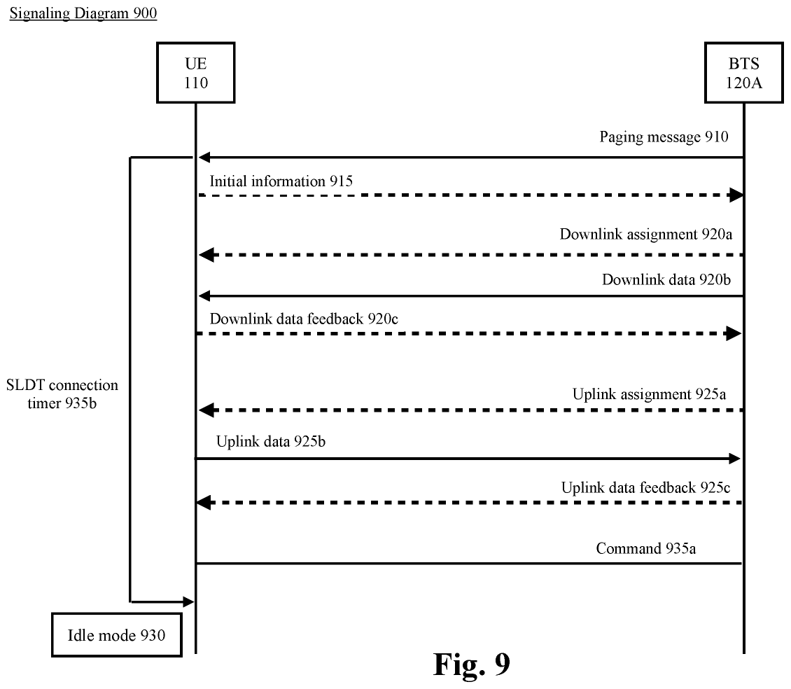

In another aspect, the exemplary embodiments introduce SLDT connection Type1 and SLDT connection Type2. As will be described in more detail below, the main difference between SLDT connection Type 1 and SLDT connection Type 2 is the number of transmissions that may be performed during the SLDT connection. SLDT connection Type1 will be described in more detail below with regard to FIGS. 6-8 and SLDT connection Type 2 will be described in more detail below with regard to FIG. 9. However, reference to the terms SLDT connection Type1 and SLDT connection Type2 are merely provided for illustrative purposes, different entities may refer to similar concepts by a different name.

SLDT connection Type1 may refer to an SLDT connection that is used for a single downlink data transmission and/or a single uplink data transmission. In some embodiments, SLDT connection Type1 may be limited to a maximum number of downlink packets and/or a maximum number of uplink packets. For example, the SLDT connection Type1 may be used for small data transmissions where a maximum of one downlink packet and/or one uplink packet without any retransmissions (e.g., request and response transaction).

FIG. 6 shows a signaling diagram 600 for SLDT connection Type1 according to various exemplary embodiments. The signaling diagram 600 includes the UE 110 and the BTS 120A.

Initially, consider a scenario where the UE 110 is in an idle mode. When in idle mode the UE 110 is generally not exchanging data with the network and radio resources are not being assigned to the UE 110 within the network. For example, the UE 110 may be in radio resource control (RRC) idle mode. However, the exemplary embodiments are not limited to RRC idle mode and may be applied to RRC inactive mode or any other mode of operation where the UE 110 discontinues at least a subset of its data exchange processing functionality. According to some aspects, the exemplary embodiments may use a mode similar to RRC inactive. However, unlike the RRC inactive concept, there may not be a need to maintain any AS context for the UE or reserve dedicated SLDT configurations for the UE.

In 610, the BTS 120A transmits a paging message to the UE 110. For SLDT connection Type1, the paging message may be referred to as “Msg1A.” Msg1A may trigger the UE 110 to start an SLDT connection Type1. In some embodiments, Msg1A may also indicate whether an uplink data transfer is to be scheduled. However, reference to the term “Msg1A” is merely provided for illustrative purposes, different entities may refer to a similar concept by a different name.

In 615a, the BTS 120A may transmit a downlink assignment to the UE 110. In 615b, the BTS 120A may transmit downlink data to the UE 110. The downlink data may be repeated multiple times if data repetition is enabled to reduce the probability of a downlink payload transmission failure.

The downlink assignment and the downlink data may be collectively referred to as “Msg2A.” In some scenarios, the SLDT connection may not be used to provide downlink data to the UE 110 and thus, Msg2A may not be used during the SLDT connection. For example, the SLDT connection may be established for the UE 110 to provide periodic uplink data to the UE 110. However, reference to the term “Msg2A” is merely provided for illustrative purposes, different entities may refer to a similar concept by a different name.

In addition, the downlink assignment in 615a may be optional based on the SLDT configuration set (e.g., static or dynamic assignment). The different types of SLDT configuration sets will be described in more detail below with regard to the exemplary resource allocation techniques.

In 620a, the BTS 120A may transmit an uplink assignment to the UE 110. The uplink assignment in 620A may be optional based on the SLDT configuration set (e.g., static or dynamic assignment). In 620b, the UE 110 transmits uplink information to the BTS 120A that may be used for uplink data processing at the BTS 120A. For example, a preamble may be sent by the UE 110 to enable an uplink timing advance adjustment. In 620c, the UE 110 transmits uplink data to the BTS 120A. The uplink data may be repeated multiple times if data repetition is enabled to reduce the probability of an uplink payload transmission failure.

The uplink assignment, uplink information for processing and uplink data may be collectively referred to as “Msg3A.” In some scenarios, the SLDT connection may not be used to provide uplink data to the network and thus, Msg3A may not be used during the SLDT connection. Once the data transfer is complete (e.g., 615a or 620c), the SLDT connection Type1 ends, and the UE 110 may return to its idle mode. However, reference to the term “Msg3A” is merely provided for illustrative purposes, different entities may refer to a similar concept by a different name.

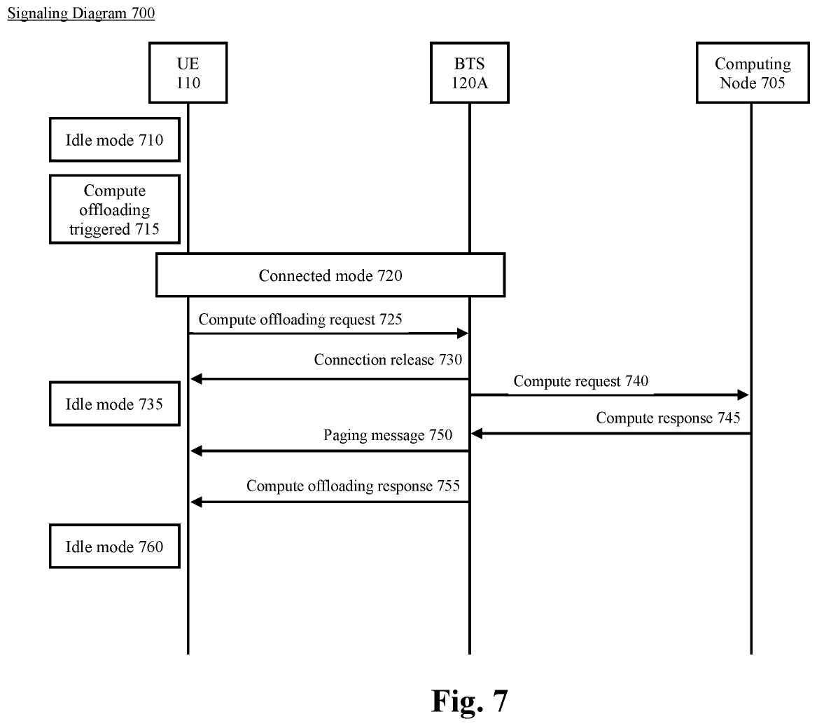

FIG. 7 shows a signaling diagram 700 for computation offloading using SLDT connection Type1 according to various exemplary embodiments. The signaling diagram 700 includes the UE 110, the BTS 120A and a computing node 705 of the core network 130. As will be described in detail below, in this example, the UE 110 requests to offload one or more computation tasks to the core network 130. The request is provided during a non-SLDT type connection, e.g., RRC connection or in any other appropriate manner. The network then uses SLDT connection Type1 to provide the computation results to the UE 110.

In 710, the UE 110 is in an idle mode. In 715, compute offloading is triggered. In 720, the UE 110 connects to the BTS 120A and enters an RRC connected mode.

In 725, the UE 110 transmits a compute offloading request to the BTS 120A. The compute offloading request may include computation data that the UE 110 wants to be processed by the computing node 705 of the core network 130. In 730, the BTS 120A may release the connection to the UE 110 and in 735 the UE 110 may return to its idle mode.

On the network side, in 740, the BTS 120A may transmit a compute request to the computing node 705 comprising the computation data provided by the UE 110 in 725. In 745, the computing node 705 transmits a compute response to the BTS 120A. In this example, it is assumed that the computing node 705 successfully performed the computing task and the compute response comprises a computation result based on the computation data.

In 750, the BTS 120A may transmit a paging message to the UE 110. The paging message may include an indication that an SLDT connection Type1 is to be used for downlink data only. In 755, the BTS 120A transmits a compute offloading response to the UE 110 comprising downlink data. For example, the compute offloading response may include the computation result from the computing node 705. In this example, since the SLDT connection Type1 is to only be used for downlink data, the SLDT connection ends after the reception of the downlink data in 755. In 760, the UE 110 returns to idle mode.

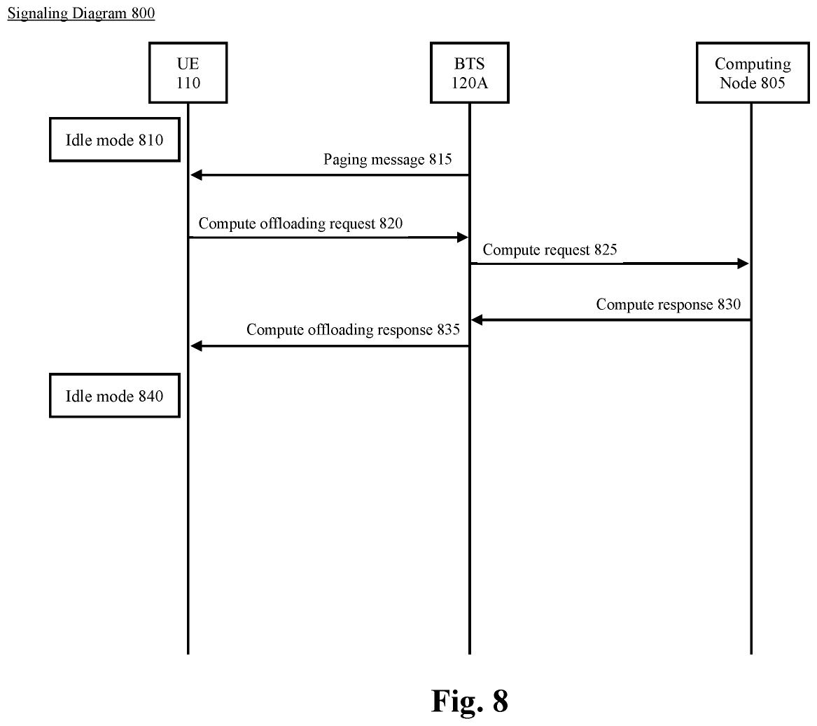

FIG. 8 shows a signaling diagram 800 for computing offloading using SLDT connection Type1 according to various exemplary embodiments. The signaling diagram 800 includes the UE 110, the BTS 120A and a computing node 805 of the core network 130. In contrast to the example provided above with regard to the signaling diagram 700, the UE 110 requests to offload one or more computation tasks and receives the computation results during the same SLDT Type1 connection.

In 810, the UE 110 is in idle mode. In 815, the BTS 120A transmits a paging message to the UE 110. The paging message may include an indication that an SLDT connection Type1 is to be used for downlink and uplink data.

In 820, the UE 110 transmits a compute offloading request to the BTS 120A comprising computation data for processing by the computing node 805. In 825, the BTS 120A transmits a compute request to the computing node 805 comprising the computation data provided by the UE 110. In 830, the computing node 805 transmits a compute response to the BTS 120A comprising a computation result based on processing the computation data provided by the UE 110.

In 835, the BTS 120A transmits a compute offloading response to the UE 110 comprising downlink data. For example, the compute offloading response may include the computation result from the computing node 805. Since uplink data was already provided in 820, the SLDT connection ends after the reception of the downlink data in 835. In 840, the UE 110 returns to idle mode.

SLDT connection Type2 may refer to an SLDT connection that is used for multiple downlink data transmissions and/or multiple uplink data transmissions. In some embodiments, SLDT connection Type2 may incorporate hybrid automatic repeat request (HARQ) or any other appropriate type of retransmission scheme.

FIG. 9 shows a signaling diagram 900 for SLDT connection Type2 according to various exemplary embodiments. The signaling diagram 900 includes the UE 110 and the BTS 120A.

Initially, consider a scenario where the UE 110 is in an idle mode. When in the idle mode the UE 110 is generally not exchanging data with the network and radio resources are not being assigned to the UE 110 within the network. For example, the UE 110 may be in RRC idle mode. However, the exemplary embodiments are not limited to RRC idle mode and may be applied to RRC inactive mode or any other mode of operation where the UE 110 discontinues at least a subset of its data exchange processing functionality.

In 910, the BTS 120A transmits a paging message to the UE 110. For SLDT connection Type2, the paging message may be referred to as “Msg1B.” Msg1B may trigger the UE 110 to start an SLDT connection Type2. In some embodiments, Msg1B may also indicate whether an uplink data transfer is to be scheduled. However, reference to the term “Msg1B” is merely provided for illustrative purposes, different entities may refer to a similar concept by a different name.

In 915, the UE 110 transmits initial information to the BTS 120A. The initial information may include information that may be used by the network to adjust radio resource assignments for the UE 110 and process uplink data received from the UE 110. For example, the initial information may include a preamble or some other type of information that may be used for timing advance adjustments. In another example, the initial information may include channel state information (CSI) that enable the network to manage radio resource utilization. In a further example, the initial information may include an indication of the pending uplink data size. For SLDT connection Type2, the initial information may be referred to as “Msg2B.” However, reference to the term “Msg2B” is merely provided for illustrative purposes, different entities may refer to a similar concept by a different name.

In 920a, the BTS 120A may transmit a downlink assignment to the UE 110. The downlink assignment in 920a may be optional based on the SLDT configuration set (e.g., static or dynamic assignment). The different types of SLDT configuration sets will be described in more detail below with regard to the exemplary resource allocation techniques.

In 920b, the BTS 120A transmits downlink data to the UE 110. In some embodiments, the downlink data payload may include information that indicates to the UE 110 information about the uplink data transfer such as, but not limited to, uplink timing advance information and power control related information.

In 920c, the UE 110 may transmit downlink data feedback to the BTS 120A. The downlink data feedback may include one or more acknowledgement (ACKs), one or more negative acknowledgement (NACKs) and/or a request for a retransmission. However, in some embodiments, SLDT connection Type2 may not use a retransmission scheme and downlink data feedback may not be utilized.

The downlink assignment, downlink data and downlink data feedback of 920a-920c may be collectively referred to as “Msg3B.” The number of messages encompassed by Msg3B may vary based on pending downlink data and retransmissions needed (if any). However, reference to the term “Msg3B” is merely provided for illustrative purposes, different entities may refer to a similar concept by a different name.

In 925a, the BTS 120A may transmit an uplink assignment to the UE 110. The downlink assignment in 920a may be optional based on the SLDT configuration set (e.g., static or dynamic assignment). The different types of SLDT configuration sets will be described in more detail below with regard to the exemplary resource allocation techniques.

In 925b, the UE 110 transmits uplink data to the BTS 120A. In 925c, the BTS 120A transmits uplink data feedback to the UE 110. The uplink data feedback may include one or more ACKs, one or more NACKs and/or a request for retransmission. However, in some embodiments, SLDT connection Type2 may not use a retransmission scheme and uplink data feedback may not be utilized.

The uplink assignment, uplink data and uplink data feedback of 925a-925c may be collectively referred to as “Msg4B.” The number of messages encompassed by Msg4B may vary based on pending uplink data and a number of retransmissions needed (if any). However, reference to the term “Msg4B” is merely provided for illustrative purposes, different entities may refer to a similar concept by a different name.

In 930, the SLDT connection Type2 ends and the UE 110 returns to idle mode. In some embodiments, the BTS 120A may send a command to the UE 110 indicating the end of the SLDT connection. An example of this command is shown in the signaling diagram 900 as 935a. The command may be provided via downlink control information (DCI), a medium access control (MAC) control element (CE) or in any other appropriate manner. This command may be referred as “Msg5B.” However, reference to the term “Msg5B” is merely provided for illustrative purposes, different entities may refer to a similar concept by a different name.

In other embodiments, the UE 110 may operate a timer that is used to trigger the end of SLDT connection Type2. An example of this timer is shown in the signaling diagram 900 as 935b. The UE 110 may initiate an SLDT connection timer in response to the paging message received in 910. A timeout may occur if a type of message or command is not received within a certain time window. For example, if the connection-end command is not received in 935a prior to the expiration of the SLDT connection timer, the UE 110 may declare a timeout and the SLDT connection Type2 ends. However, the above example is merely provided for illustrative purposes, the exemplary SLDT connection timer may be operated in an appropriate manner to ensure that the UE 110 does not maintain the SLDT connection for an unnecessary amount of time.

According to some aspects, the exemplary embodiments introduce paging mechanisms for SLDT. The network may not be aware of the exact cell on which the UE 110 is camping. The following exemplary embodiments may be used to determine on which cell the network is to initiate the SLDT connection with the UE 110.

In some embodiments, sending a paging message to initiate an SLDT connection may be limited to a last serving cell or area based on a device type. For example, consider a scenario in which the UE 110 is a stationary device (e.g., IoT sensor, etc.). The network may only initiate an SLDT connection on a last serving cell for the UE 110 because the UE 110 is a stationary device and the network may assume that the UE 110 has not moved since the last time the UE 110 communicated with the network.

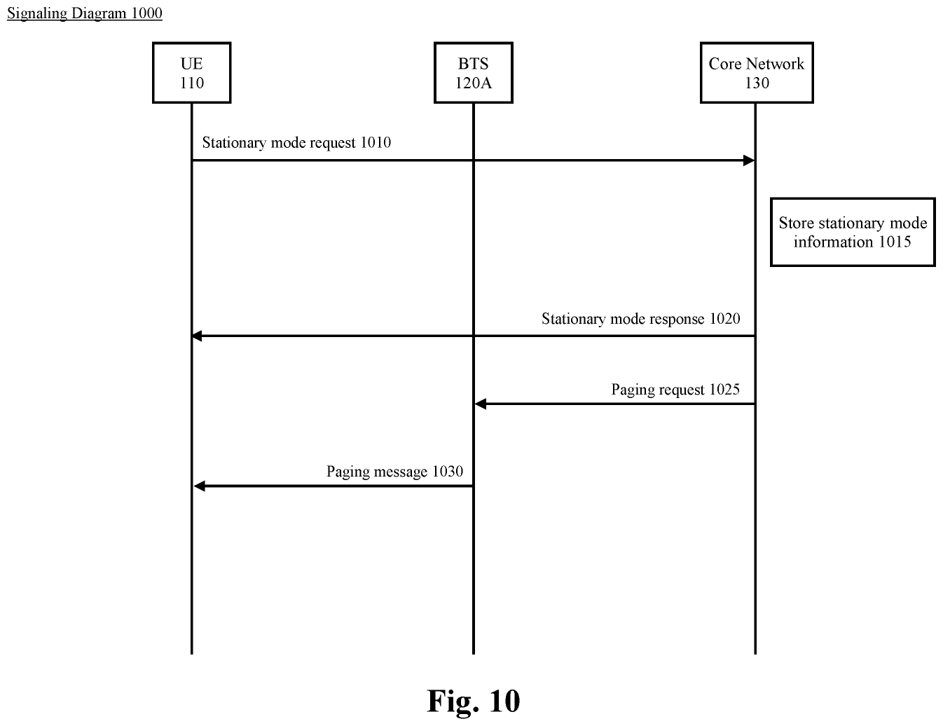

In some embodiments, the network may utilize a localized paging approach. FIG. 10 shows a signaling diagram 1000 for localized paging according to various exemplary embodiments. The signaling diagram 1000 includes the UE 110, the BTS 120A and the core network 130.

The signaling diagram 1000 is described with regard to a UE operating mode referred to as “stationary mode.” As will be described in more detail below, the exemplary embodiments utilize stationary mode to determine which cell to use to send a paging message to the UE 110 for SLDT.

The term “stationary mode” refers to a state where the UE 110 is deployed as a stationary device or a device with low mobility. For example, the UE 110 may be an IoT sensor that is configured at a first location and then delivered to a second location where the UE 110 will perform its configured task. At the second location, the UE 110 may be placed in a stationary mode which indicates to the UE 110 and/or the network that the UE 110 that the device will be operating in a stationary or low mobility state. This allows the UE 110 and/or the network to behave with the assumption that the UE 110 will be located at approximately a same location. However, reference to the term “stationary mode” is merely provided for illustrative purposes, different entities may refer to a similar concept by a different name.

Initially, consider the UE 110 is connected to the network with a normal connection (e.g., RRC connected mode). In 1010, the UE 110 sends a stationary mode request to the core network 130. The UE 110 may register with the network indicating that it is entering stationary mode with a particular serving cell or within a particular area. In some embodiments, the stationary mode request may be sent as part of a NAS registration procedure or a tracking area update (TAU) procedure and include information about the serving cell and/or location where stationary mode was triggered. In some embodiments, the UE 110 may trigger stationary mode based on being within a certain location and/or being in a stationary or low mobility state for certain amount of time. However, the example provided above are merely provided for illustrative purposes, the stationary mode request may be provided to the network in any appropriate manner.

In 1015, the core network 130 stores an indication that the UE 110 is to operate in stationary mode along with the current UE 110 serving cell information. In 1020, the core network 130 sends a stationary mode response to the UE 110. In this example, it is assumed that the stationary mode request has been accepted and thus, the stationary mode response may include an indication that stationary mode is confirmed. However, in an actual deployment scenario, for any of a variety of different reasons, the core network 130 may not accept the stationary mode request and the stationary mode response may include a stationary mode reject message.

In 1020, the core network 130 determines that a SLDT connection to the UE 110 is to be established. For example, there may be pending downlink data for the UE 110. In another example, the network may be triggered to establish an SLDT connection based on a schedule or some other time-based factor (e.g., a time, a date, etc.). In a further example, the core network 130 may receive a request from the UE 110 or a signal from another UE or remote device indicating that the UE 110 is to receive data and/or transmit data. However, the above examples are merely provided for illustrative purposes. The core network 130 may decide to establish an SLDT connection with the UE 110 for any appropriate reason.

In 1025, the core network 130 sends the paging request to the BTS 120A for the UE 110. Since the UE 110 is in stationary mode, the core network 130 may page the UE 110 for a SLDT connection using the serving cell information stored in 1015. In 1030, the BTS 120A sends a paging message to the UE 110 for SLDT connection (e.g., SLDT connection Type1, SLDT connection Type2, etc.). Examples of UE side and network side behavior in response to the paging message is shown in the various signaling diagrams described above with regard to FIGS. 4 and 6-9.

Although not show in the signaling diagram 1000, the UE 110 may subsequently identify a condition triggering the UE 110 to exit stationary mode. In this type of scenario, the UE 110 may send a message to the network indicating that the UE 110 has exited stationary mode. In some embodiments, instead of indicating that the UE 110 has exited stationary mode, the UE 110 may transmit a message to the UE 110 to update the network with new serving cell information or location information so the network may update the stored association for the UE 110.

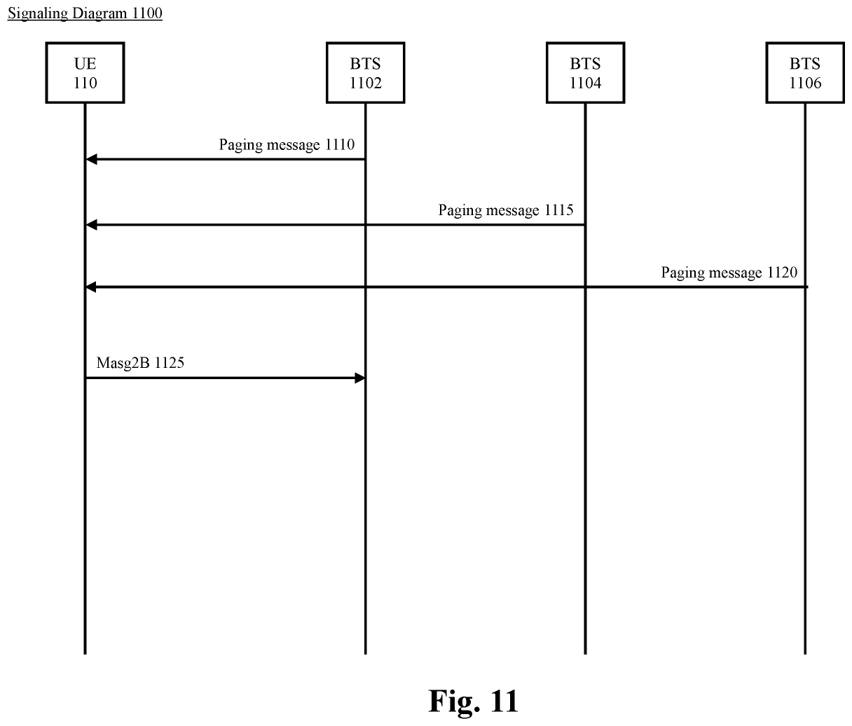

FIG. 11 shows a signaling diagram 1100 for paging the UE 110 from multiple cells for SLDT according to various exemplary embodiments. The signaling diagram 1100 include the UE 110, a BTS 1102, BTS 1104 and BTS 1106.

According to some embodiments, the UE 110 may be paged in multiple cells with SLDT connection Type2. In 1110, BTS 1102 sends a paging message to the UE 110 for SLDT connection Type2. In 1115, BTS 1104 sends a paging message to the UE 110 for SLDT connection Type2. In 1120, the BTS 1106 sends a paging message to the UE 110 for SLDT connection Type2.

In 1125, the UE 110 sends Msg2B to BTS 1102. In this example, only the cell receiving SLDT connection Type2 Msg2B will continue the SLDT connection with the UE 110. Since BTS 1104 and BTS 1106 have not received a response form the UE 110, the network may stop the SLDT connection at BTS 1104 and BTS 1106. Since BTS 1102 received the response to the paging message, BTS 1102 may receive downlink data for the UE 110 from the core network and continue the signaling for SLDT connection Type2. The signaling for SLDT connection Type2 is described above with regard to at least the signaling diagram 900 of FIG. 9.

According to other aspects, the exemplary embodiments introduce techniques for SLDT resource allocation. As mentioned above, the exemplary embodiments are described with regard to different SLDT configuration sets. Throughout this description, an SLDT configuration set refers to a set of radio resources that may be used by a single UE during an SLDT connection. The UE may know the location of the radio resources for the SLDT configuration set based on SLDT configuration information. However, reference to the term SLDT configuration set is provided for illustrative purposes, different entities may refer to a similar concept by a different name.

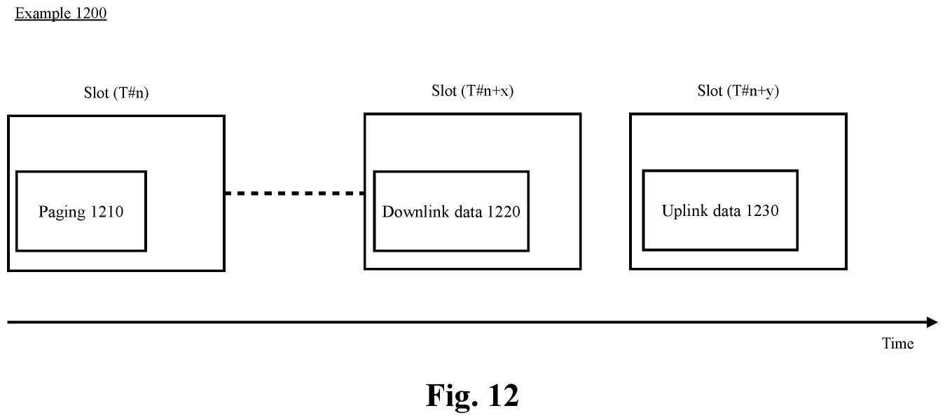

FIG. 12 shows an example 1200 of a mapping between a paging message and a SLDT configuration set according to various exemplary embodiments. In example 1200, a paging message 1210 for UE 110 is shown at slot (T #n). The paging message is mapped to one of multiple SLDT configuration sets based on broadcast or dedicated SLDT configuration information. In this example, the SLDT configuration set indicates radio resources for downlink data 1220 to be sent to the UE 110 at a second slot (T #n+x) where the value of x is indicated by the SLDT configuration information. Similarly, the SLDT configuration set include radio resources for uplink data 1230 to be transmitted by the UE 110 at a third slot (T #n+y) where the value of y is also indicated by the SLDT configuration set. The example 1200 is provided as one example of an SLDT configuration set and is not intended to limit the exemplary embodiments in any way.

As indicated above there may be multiple SLDT configuration sets that are each to be used by a different UE. In one exemplary scheme, the mapping between the paged UEs and SLDT configuration sets may be indicated by the UE order in the paging message. For example, consider a scenario where multiple UEs are paged in the same paging message and SLDT configuration sets are indexed 0-N. The first UE to be paged in the paging message for the SLDT connection may have an implicit mapping with the SLDT configuration set indexed 0. The next UE to be paged in the same paging message for the SLDT connection may have an implicit mapping with the SLDT configuration set 1. Thus, the order in which UEs are paged in a same paging message for the SLDT connection may indicate which SLDT configuration set is to be used for that UE.

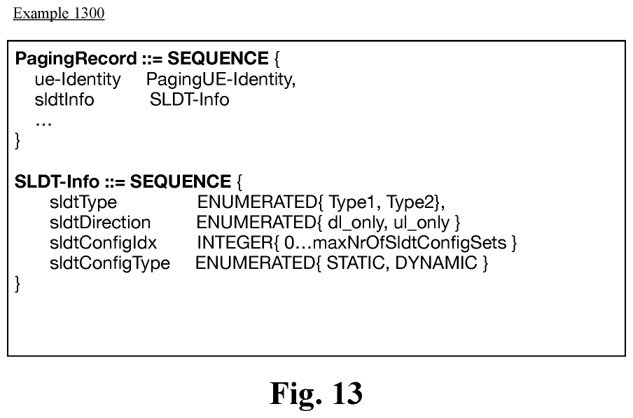

In another exemplary scheme, the mapping between paged UEs and SLDT configuration sets may be explicitly provided in the paging message. FIG. 13 shows an example 1300 of a paging record that may be provided in a paging message according to various exemplary embodiments. The paging record may include a UE identity and SLDT information (SLDT-info).

The SLDT-info may include a sldtType parameter configured to indicate whether SLDT connection Type1 or SLDT connection Type2 is to be utilized and a sldtDirection parameter configured to indicate whether the SLDT connection is for uplink only, downlink only or both. In addition, the SLDT-info may include a sldtConfigIdx parameter that is configured to indicate a SLDT configuration set index to be used by the UE. The parameter may be a value of 0 to a maximum number of SLFT configuration sets (maxNrOfSldtConfigSets). Further, the SLDT-info may include a sldtConfigType parameter configured to indicate whether the SLDT resources are static or dynamic. The example 1300 is provided as one example of an SLDT configuration set and is not intended to limit the exemplary embodiments in any way.

In another exemplary scheme, the UE may be preconfigured with a semi-dedicated SLDT configuration. With this scheme, the UE 110 may apply the preconfigured SLDT configuration in response to a paging message. The above exemplary schemes are provided as examples and are not intended to limit the exemplary embodiments in any way. The exemplary embodiments may provide UEs with SLDT configuration information to indicate which radio resources are to be used by the UE 110 during an SLDT connection in any appropriate manner.

Since the SLDT configuration set usage by UEs is triggered by a mobile terminating connection message (e.g., paging), if an SLDT configuration set is not to be utilized by any UEs, the network may utilize the corresponding radio resources for other radio activities. For example, a base station may have a relatively large number of SLDT configuration sets configured/broadcasted. If there are no UEs scheduled to use a SLDT configuration set, their corresponding resources may be utilized by the network for any other purpose. Thus, it is under network control if SLDT radio resources are to be used for SLDT connections or for other activities.

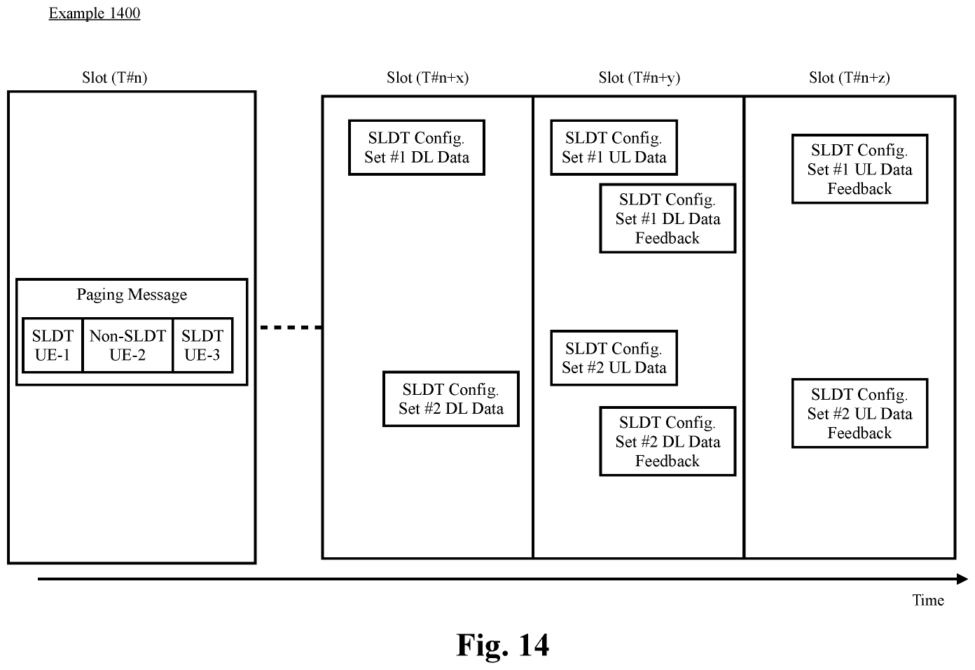

FIG. 14 shows an example 1400 of a static allocation of resources for SLDT according to various exemplary embodiments. With this approach, the SLDT configuration information defines the radio resources and parameters that may be used for uplink and/or downlink data transfer. For example, the SLDT configuration information may indicate the physical resource blocks (PRBs), time domain information (e.g., slot, symbols, etc.) and their repetition patterns. In addition, the SLDT configuration information may include receive (RX)/transmit (TX) parameters such as modulation and channel coding schemes. The information provided by the network means that the UE 110 will perform minimal physical layer activities. For example, the UE 110 does not need to monitor the physical layer common control channel for grants because the UE 110 is configured based on the SLDT configuration information.

In example 1400, a paging message is provided at a slot (T #n) comprising SLDT configuration information for UE-1 and UE-3. The paging message also includes information for a UE (UE-2) that is not configured for SLDT. In this example, the paging record for UE-1 maps to SLDT configuration set #1 and the paging message for UE-3 maps to SLDT configuration set #2.

SLDT configuration set #1 maps to radio resources shown in example 1400 at slots (T #n+x), (T #n+y) and (T #n+z). At slot (T #n+x) downlink resources are allocated to the UE-1 for downlink data. At slot (T #n+y) uplink resources are allocated to the UE-1 for uplink data and uplink resources for downlink data feedback. At slot (T #n+z) downlink resources are allocated to the UE-1 for uplink data feedback.

SLDT configuration set #2 maps to radio resources shown in example 1400 at slots (T #n+x), (T #n+y) and (T #n+z). At slot (T #n+x) downlink resources are allocated to the UE-3 for downlink data. At slot (T #n+y) uplink resources are allocated to the UE-3 for uplink data and uplink resources for downlink data feedback. At slot (T #n+z) downlink resources are allocated to the UE-3 for uplink data feedback.

In example 1400, SLDT configuration sets #3 and #4 are not assigned to any UE and thus, the network may use the corresponding radio resources for any other appropriate purpose.

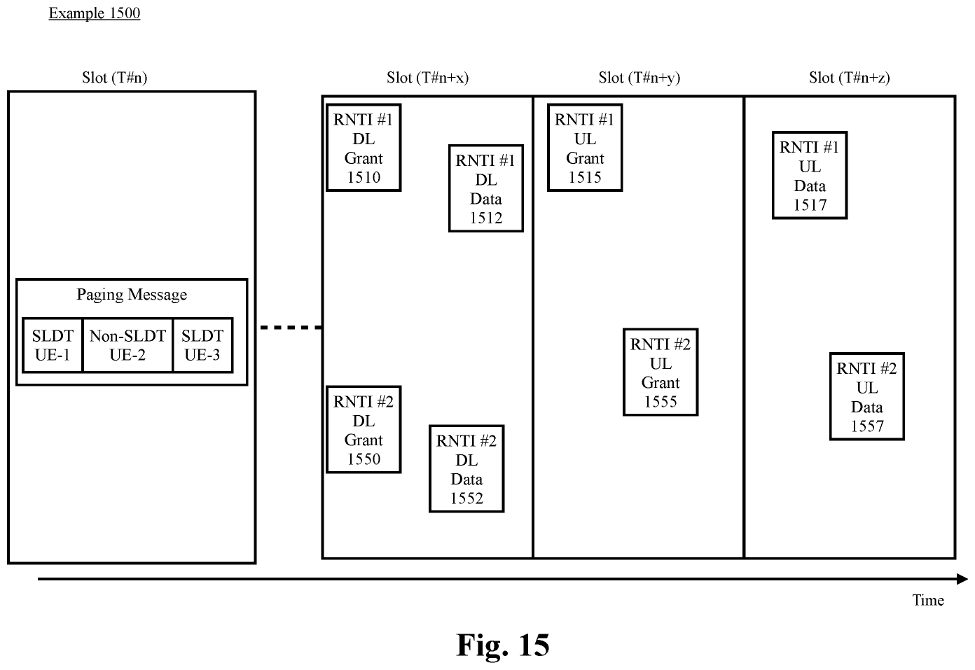

FIG. 15 shows an example 1500 of a dynamic allocation of resources for SLDT according to various exemplary embodiments. With this approach, the SLDT configuration information defines a minimal amount of information to perform SLDT. For example, the SLDT configuration information may include a radio network temporary identified (RNTI) corresponding to a SLDT configuration set. The UE 110 may then monitor physical layer common control channels (e.g., physical downlink common control channel (PDCCH), etc.) for radio resource assignments associated with the corresponding identifier.

In example 1500, a paging message is provided at a first slot (T #n) comprising SLDT configuration information for UE-1 and UE-3. The paging message also includes information for a UE (UE-2) that is not using SLDT. In this example, the paging record for UE-1 maps to SLDT configuration set #1 corresponding to RNTI #1 and the paging message for UE-3 maps to SLDT configuration set #2 corresponding to RNTI #2.

RNTI #1 is used to transmit a downlink grant 1510 to UE-1 at slot (T #n+x). The downlink grant 1510 may indicate the downlink data 1512 is also to be transmitted to UE-1 during slot (T #n+x). RNTI #1 may also be used to transmit an uplink grant 1515 to UE-1 at slot (T #n+y). The uplink grant 1515 may indicate the uplink data 1517 is to be transmitted by UE-1 at slot (T #n+z). Although not show in the example 1500, the radio resources for downlink data feedback may have a predefined offset relative to the downlink data 1512 or may be indicated to the UE 110 in either the downlink grant 1510 or the uplink grant 1515. Similarly, the radio resources for uplink data feedback may have a predefined offset relative to the uplink data 1517 or may be indicated to the UE 110 in either the downlink grant 1510 or the uplink grant 1515.

RNTI #2 is used to transmit a downlink grant 1550 to UE-3 at slot (T #n+x). The downlink grant 1550 may indicate the downlink data 1552 is also to be transmitted to UE-3 during slot (T #n+x). RNTI #2 may also be used to transmit an uplink grant 1555 to UE-2 at slot (T #n+y). The uplink grant 1555 may indicate the uplink data 1557 is to be transmitted by UE-3 at slot (T #n+z). Although not show in the example 1500, the radio resources for downlink data feedback may have a predefined offset relative to the downlink data 1552 or may be indicated to the UE 110 in either the downlink grant 1550 or the uplink grant 1555. Similarly, the radio resources for uplink data feedback may have a predefined offset relative to the uplink data 1557 or may be indicated to the UE 110 in either the downlink grant 1550 or the uplink grant 1555.

### EXAMPLES

In a first example, a method is performed by a user equipment (UE), comprising receiving configuration information comprising multiple configuration sets, receiving a paging message from a base station, the paging message configured to initiate a mobile terminating connection between the UE and the base station, identifying a first configuration set assigned to the UE from the multiple configuration sets based on the paging message and exchanging data with a network using the first configuration set, wherein exchanging data with network comprises at least one of receiving downlink data and transmitting uplink data.

In a second example, the method of the first example, wherein the paging message indicates a first type of mobile terminating connection from a set of two different types of mobile terminating connections.

In a third example, the method of the second example, wherein the first type of mobile terminating connection is configured to include multiple messages including at least a downlink message comprising downlink data or an uplink message comprising uplink data.

In a fourth example, the method of the third example, wherein the paging is a first message of the first type of mobile terminating connection and a second message of the first type of mobile terminating connection comprises the downlink data.

In a fifth example, the method of the fourth example, wherein the second message further comprises a downlink assignment for the downlink data.

In a sixth example, the method of the fourth example, wherein the second message further comprises downlink data feedback in response to the downlink data.

In a seventh example, the method of the third example, wherein the paging is a first message of the first type of mobile terminating connection and a second message of the first type of mobile terminating connection comprises the uplink data.

In an eighth example, the method of the seventh example, wherein the second message further comprises an uplink assignment for the uplink data.

In a ninth example, the method of the seventh example, wherein the second message further comprises uplink data feedback in response to the uplink data.

In a tenth example, the method of the first example, wherein identifying the first configuration assigned to the UE is based on a UE order in the paging message, wherein the UE order corresponding to a configuration set index.

In an eleventh example, the method of the first example, wherein identifying the first configuration assigned to the UE is based on a configuration set index value included in the paging message.

In a twelfth example, the method of the first example, wherein the first configuration set defines radio resources to be used for the exchanging data with the network.

In a thirteenth example, the method of the first example, wherein the first configuration set further comprises transmit (TX) or receive (RX) parameters for the mobile terminating connection.

In a fourteenth example, the method of the first example, wherein the first configuration set comprises a UE identifier that is to be used by the network to address a downlink assignment or uplink assigned transmitted to the UE during the mobile terminating connection.

In a fifteenth example, the method of the first example, further comprising identifying a condition triggering a stationary mode for the UE and transmitting a stationary mode request to the base station, the stationary mode request comprising information associated with a serving cell or location of the UE, wherein the network uses the information associated with the serving cell or location of the UE to select the base station for providing the paging message to the UE.

In a sixteenth example, the method of the fifteenth example, further comprising transmitting a message to the base station, the message indicating that the UE has exited stationary mode.

In a seventeenth example, the method of the fifteenth example, further comprising transmitting a message to the base station, the message comprising updated serving cell information or update location information for stationary mode.

In an eighteenth example, the method of the first example, further comprising receiving a command from the network, the command indicating an end of the mobile terminating connection.

In a nineteenth example, the method of the first example, wherein the UE is configured to end the mobile terminating connection in response to an expiration of a timer.

In a twentieth example, the method of the first example, wherein exchanging data with the network comprises receiving a downlink data repetition.

In a twenty first example, the method of the ninth example, wherein the second message further comprises one or more retransmissions in response to the uplink data feedback.

In a twenty second example, the method of the first example, wherein the first configuration set comprises radio resources the UE is to monitor for uplink or downlink radio resource assignments.

In a twenty third example, the method of the first example, wherein the first configuration set comprises an indication of physical resource blocks (PRBs), time domain information and repetition patterns.

In a twenty fourth example, a method is performed by a base station, comprising transmitting a paging message to a user equipment (UE), the paging message configured to initiate a mobile terminating connection between the UE and the base station, identifying a first configuration set assigned to the UE from multiple configuration sets and exchanging data with the UE using the first configuration set, wherein exchanging data with network comprises at least one of receiving downlink data and transmitting uplink data.

In a twenty fifth example, the method of the twenty fourth example, further comprising transmitting configuration information comprising the multiple configuration sets to the UE in a system information block (SIB).

In a twenty sixth example, the method of the twenty fourth example, further comprising transmitting configuration information comprising the multiple configuration sets to the UE in a dedicated message.

In a twenty seventh example, the method of the twenty fourth example, wherein the first configuration set is assigned to only the UE during the mobile terminating connection.

In a twenty eighth example, the method of the twenty fourth example, wherein radio resources corresponding to the first configuration set are available for any radio activity when the mobile terminating connection utilizing these resources is not assigned to any UE.

In a twenty ninth example, the method of the twenty fourth example, further comprising receiving a paging request from a core network based on previously being a serving cell for the UE.

In a thirtieth example, the method of the twenty ninth example, wherein the UE transmitted an indication of a UE stationary mode to the core network via a previous connection between the UE and the base station.

In a thirty first example, the method of the twenty fourth example, wherein a data payload structure for the mobile terminating connection comprises a header, user plane data and integrity code, wherein a non-access stratum (NAS) security context is used for user plane data protection, and wherein a NAS layer generated integrity code is used for authentication.

In a thirty second example, the method of the twenty fourth example, wherein a data payload structure for the mobile terminating connection comprises a header, user plane data and integrity code, wherein an access stratum (AS) security context is used for user plane data protection, and wherein an AS layer generated integrity code is used for authentication.

In a thirty third example, the method of the twenty fourth example, wherein the mobile terminating connection is a type of connection configured for a maximum number of downlink packets and wherein the mobile terminating connection ends after the maximum number of downlink packets are received.

In a thirty fourth example, the method of the twenty fourth example, wherein the mobile terminating connection is a type of connection configured for a maximum number of uplink packets and wherein the mobile terminating connection ends after the maximum number of uplink packets are transmitted.

In a thirty fifth example, the method of the twenty fourth example, wherein the paging message indicates a first type of mobile terminating connection from a set of two different types of mobile terminating connections.

In a thirty sixth example, the method of the thirty fifth example, wherein the first type of mobile terminating connection is configured to include three messages.

In a thirty seventh example, the method of the thirty fifth example, wherein the paging message is a first message of the first type of mobile terminating connection and a second message of the first type of mobile terminating connection comprises downlink data.

In a thirty eighth example, the method of the thirty seventh example, wherein the second message further comprises a downlink assignment for the downlink data.

In a thirty ninth example, the method of the thirty fourth example, wherein the paging message is a first message of the first type of mobile terminating connection and a second message of the first type of mobile terminating connection comprises uplink data.

In a fortieth example, the method of the thirty ninth example, wherein the second message further comprises an uplink assignment for the uplink data.

In a forty first example, the method of the thirty ninth example, wherein the second message further comprises uplink information for uplink data processing at the base station.

In a forty second example, the method of the thirty fourth example, wherein the first type of mobile terminating connection is configured to include at least four messages.

In a forty third example, the method of the forty second example, wherein the paging message is a first message of the first type of mobile terminating connection and a second message of the first type of mobile terminating connection comprises initial information to be used by the network for radio resource management.

In a forty fourth example, the method of the forty third example, wherein the initial information comprises at least one of a preamble and channel state information (CSI).

In a forty fifth example, the method of the forty fourth example, wherein the paging is a first message of the first type of mobile terminating connection and a second message of the first type of mobile terminating connection comprises downlink data.

In a forty sixth example, the method of the forty fifth example, wherein the second message further comprises a downlink assignment for the downlink data.

In a forty seventh example, the method of the thirty fifth example, wherein the second message further comprises downlink data feedback in response to the downlink data.

In a forty eighth example, the method of the forty second example, wherein the paging is a first message of the first type of mobile terminating connection and a second message of the first type of mobile terminating connection comprises uplink data.

In a forty ninth example, the method of the forty eighth example, wherein the second message further comprises an uplink assignment for the uplink data.

In a fiftieth example, the method of the forty eighth example, wherein the second message further comprises uplink data feedback in response to the uplink data.

In a fifty first example, the method of the twenty fourth example, wherein the first configuration assigned to the UE is indicated to the UE based on a UE order in the paging message, wherein the UE order corresponding to a configuration set index.

In a fifty second example, the method of the twenty fourth example, wherein the first configuration assigned to the UE is indicated to the UE based on a configuration set index value included in the paging message.

In a fifty third example, the method of the twenty fourth example, wherein the first configuration set defines radio resources to be used for the exchanging data with the UE.

In a fifty fourth example, the method of the twenty fourth example, wherein the first configuration set further comprises transmit (TX) or receive (RX) parameters for the mobile terminating connection.

In a fifty fifth example, the method of the twenty fourth example, wherein the first configuration set comprises a UE identifier that is to be used by the network to address a downlink assignment or uplink assigned transmitted to the UE during the mobile terminating connection.

In a fifty sixth example, the method of the twenty fourth example, further comprising transmitting a command to the UE, the command indicating an end of the mobile terminating connection.

In a fifty seventh example, the method of the twenty fourth example, wherein the UE is configured to end the mobile terminating connection in response to an expiration of a timer.

In a fifty eighth example, the method of the twenty fourth example, wherein exchanging data with the UE comprises transmitting a downlink data repetition.

In a fifty ninth example, the method of the twenty fourth example, wherein the first configuration set comprises radio resources the UE is to monitor for uplink or downlink radio resource assignments.

In a sixtieth example, the method of the twenty fourth example, wherein the first configuration set comprises an indication of physical resource blocks (PRBs), time domain information and repetition patterns.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1-20. (canceled)

21. A method performed by a base station, comprising:
transmitting a paging message to a user equipment (UE), the paging message configured to initiate a mobile terminating connection between the UE and the base station;
identifying a first configuration set assigned to the UE from multiple configuration sets; and
exchanging data with the UE using the first configuration set, wherein exchanging data with network comprises at least one of receiving downlink data and transmitting uplink data.

22. The method of claim 21, further comprising:
transmitting configuration information comprising the multiple configuration sets to the UE in a system information block (SIB).

23. The method of claim 21, further comprising:
transmitting configuration information comprising the multiple configuration sets to the UE in a dedicated message.

24. The method of claim 21, wherein the first configuration set is assigned to only the UE during the mobile terminating connection.

25. The method of claim 21, wherein radio resources corresponding to the first configuration set are available for any radio activity when the mobile terminating connection utilizing these resources is not assigned to any UE.

26. The method of claim 21, further comprising:
receiving a paging request from a core network based on previously being a serving cell for the UE.

27. The method of claim 21, wherein the UE transmitted an indication of a UE stationary mode to the core network via a previous connection between the UE and the base station.

28. The method of claim 21, wherein a data payload structure for the mobile terminating connection comprises a header, user plane data and integrity code, wherein a non-access stratum (NAS) security context is used for user plane data protection, and wherein a NAS layer generated integrity code is used for authentication.

29. The method of claim 21, wherein a data payload structure for the mobile terminating connection comprises a header, user plane data and integrity code, wherein an access stratum (AS) security context is used for user plane data protection, and wherein an AS layer generated integrity code is used for authentication.

30. The method of claim 21, wherein the mobile terminating connection is a type of connection configured for a maximum number of downlink packets and wherein the mobile terminating connection ends after the maximum number of downlink packets are received.

31. The method of claim 21, wherein the mobile terminating connection is a type of connection configured for a maximum number of uplink packets and wherein the mobile terminating connection ends after the maximum number of uplink packets are transmitted.

32. The method of claim 21, wherein the paging message indicates a first type of mobile terminating connection from a set of two different types of mobile terminating connections.

33. The method of claim 32, wherein the first type of mobile terminating connection is configured to include three messages.

34. The method of claim 32, wherein the paging message is a first message of the first type of mobile terminating connection and a second message of the first type of mobile terminating connection comprises downlink data.

35. The method of claim 34, wherein the second message further comprises a downlink assignment for the downlink data.

36. The method of claim 31, wherein the paging message is a first message of the first type of mobile terminating connection and a second message of the first type of mobile terminating connection comprises uplink data.

37. The method of claim 36, wherein the second message further comprises an uplink assignment for the uplink data.

38. The method of claim 36, wherein the second message further comprises uplink information for uplink data processing at the base station.

39. The method of claim 31, wherein the first type of mobile terminating connection is configured to include at least four messages.

40. The method of claim 39, wherein the paging message is a first message of the first type of mobile terminating connection and a second message of the first type of mobile terminating connection comprises initial information to be used by the network for radio resource management.
